(19) United States
(12) Patent Application Publication
(10) Pub. No.: US 2026/0274289 A1
(43) Pub. Date: Sep. 17, 2026

(54) Vehicle Control Apparatus and Vehicle Control Method

(71) Applicant: Astemo, Ltd., Chiyoda-ku, Tokyo (JP)

(72) Inventor: Miki KOSO, Hitachinaka-shi, Ibaraki (JP)

(21) Appl. No.: 19/166,211

(22) PCT Filed: Jan. 18, 2024
(86) PCT No.: PCT/JP2024/001239

§ 371 Date: Sep. 17, 2025

(30) Foreign Application Priority Data
Jun. 8, 2023 (JP) 2023-094586

(51) Int. Cl. B60W 60/00; B60W 40/103

(52) U.S. Cl. CPC B60W 60/001; B60W 40/103; B60W 2520/10; B60W 2520/125; B60W 2520/20; B60W 2710/20; B60W 2720/106; B60W 2720/20

(57) ABSTRACT

In a mode of a vehicle control apparatus according to the present invention, when running of a vehicle transitions from a transient state to a steady state, at least one of a target steering angular velocity and target acceleration/deceleration is controlled such that a target vehicle body sideslip angular velocity exhibits a predetermined temporal rate of change in the transient state. In addition, in a mode of a vehicle control method according to the present invention, a target steering angular velocity and target acceleration/deceleration are maintained constant in a section after a vehicle starts turning until the vehicle executes steady turning. In this way, the ground contact feel and the stability of a vehicle in a transient state during vehicle running can be improved.

### TECHNICAL FIELD

The present invention relates to vehicle control apparatuses and vehicle control methods.

### BACKGROUND ART

The vehicle steering apparatus according to Patent Document 1 includes a main steering mechanism that steers the front wheels with a steering wheel, an auxiliary steering mechanism that steers the front wheel steering angle or the rear wheels with an actuator such as a motor based on the running state of the vehicle, a vehicle body sideslip angular velocity calculation unit that detects or estimates the vehicle body sideslip angular velocity at a certain point ahead of the rear axle, and control means for controlling an actuator such that the absolute value of the vehicle body sideslip angular velocity is reduced.

### REFERENCE DOCUMENT LIST

### Patent Document

Patent Document 1: JP 2000-289637 A

### SUMMARY OF THE INVENTION

### Problem to be Solved by the Invention

When a steering mechanism is controlled such that the absolute value of a detected value or an estimated value of the vehicle body sideslip angular velocity is reduced, the future running state of the vehicle is not taken into account. For example, in a transient state in which a vehicle runs in a transitional curve section in which the road curvature gradually changes, the vehicle behavior may change, and the ground contact feel and the stability of the vehicle may deteriorate.

The present invention has been made in view of conventional circumstances, and it is an object of the present invention to provide a vehicle control apparatus and a vehicle control method that can improve the ground contact feel and the stability of a vehicle in a transient state during vehicle running.

### Means for Solving the Problem

In one mode of a vehicle control apparatus according to the present invention, when running of a vehicle transitions from a transient state to a steady state, at least one of the target steering angular velocity and target acceleration/deceleration of the vehicle is controlled such that the target vehicle body sideslip angular velocity exhibits a predetermined temporal rate of change in the transient state.

In addition, in one mode of a vehicle control method according to the present invention, the target steering angular velocity and target acceleration/deceleration of a vehicle are maintained constant in a section after the vehicle starts turning until the vehicle executes steady turning.

### Effects of the Invention

According to the present invention, the ground contact feel and the stability of a vehicle can be improved in a transient state during vehicle running.

### BRIEF DESCRIPTION OF THE DRAWINGS

FIG. 1 is a block diagram illustrating a vehicle control system.

FIG. 2 illustrates a transient state during vehicle running.

FIG. 3 illustrates a two-wheeled model for describing the correlation among a steering angular velocity, acceleration/deceleration, and vehicle body sideslip angular velocity Δβ.

FIG. 4 is a flowchart illustrating a first example of a control process of vehicle body sideslip angular velocity Δβ.

FIG. 5 is a flowchart illustrating a second example of the control process of vehicle body sideslip angular velocity Δβ.

FIG. 6 is a flowchart illustrating a third example of the control process of vehicle body sideslip angular velocity Δβ.

FIG. 7 is a time chart illustrating change in steering angle, longitudinal acceleration, etc., when the third example of the control process of vehicle body sideslip angular velocity Δβ is executed.

FIG. 8 is a block diagram illustrating a vehicle control apparatus that executes generation of a target course as the control of vehicle body sideslip angular velocity Δβ.

FIG. 9 is a block diagram illustrating a configuration of a target location conversion unit.

FIG. 10 illustrates a lateral slip amount ε at a preview location in a world coordinate system.

FIG. 11 is a flowchart illustrating a fourth example of the control process of vehicle body sideslip angular velocity Δβ.

FIG. 12 is a time chart illustrating change in the steering angle of the front and rear wheels, longitudinal acceleration, etc., when a fifth example of the control process of vehicle body sideslip angular velocity Δβ is executed.

FIG. 13 is a flowchart illustrating the fifth example of the control process of vehicle body sideslip angular velocity Δβ.

### MODE FOR CARRYING OUT THE INVENTION

Hereinafter, examples of a vehicle control apparatus and a vehicle control method according to the present invention will be described with reference to the drawings.

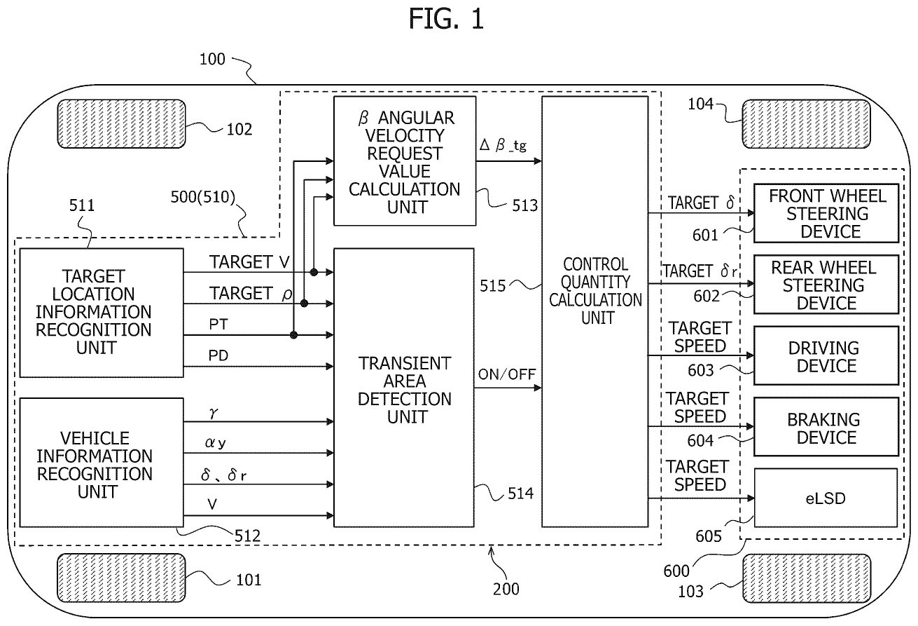

FIG. 1 is a block diagram illustrating a mode of a vehicle control system 200 mounted in a vehicle 100.

Vehicle 100 is a four-wheeled vehicle including a pair of right and left front wheels 101 and 102 and a pair of right and left rear wheels 103 and 104.

Vehicle control system 200 is an automated driving system or a driver assistance system having a function of controlling the motion of vehicle 100, and incudes a vehicle control apparatus 500 and an actuator unit 600 controlled by vehicle control apparatus 500.

Vehicle control apparatus 500 is an electronic control apparatus including a microcomputer 510 as a control unit that executes calculation based on input information and outputs a calculation result.

Microcomputer 510 includes a microprocessor unit (MPU), a read-only memory (ROM), a random access memory (RAM), etc., which are not illustrated.

Microcomputer 510 may also be referred to as a micro controller unit (MCU), a processor, a processing device, an arithmetic device, or the like.

Actuator unit 600 is a device that actively changes the behavior of vehicle 100.

Actuator unit 600 includes a front wheel steering device 601 that steers front wheels 101 and 102 by a steer-by-wire system, a rear wheel steering device 602 that steers rear wheels 103 and 104, a driving device 603 such as an internal-combustion engine or a motor that generates driving force of vehicle 100, a braking device 604 that applies braking force to wheels 101 to 104 of vehicle 100, and an electronically controlled limited-slip-differential gear (LSD) 605.

The steer-by-wire system of front wheel steering device 601 is a steering system in which the steering wheel operated by the driver is mechanically separate from front wheels 101 and 102, which are the steered road wheels. In this system, the steering angle of front wheels 101 and 102 is controlled by electrical signal.

Front wheel steering device 601, rear wheel steering device 602, driving device 603, braking device 604, and electronically controlled LSD 605 each include an actuator that can electronically control a corresponding one of the control quantities such as the steering angle, the driving force, the braking force, and the differential limiting force by electrical signal. Although the steering wheel is used as a main steering mechanism that operates front wheels 101 and 102 in the present example, an operation device of which the size, shape, etc., are freely set may be alternatively used as the main steering mechanism.

In addition, vehicle 100 may include a motor as driving device 603. In this case, the motor can be used as the braking device by causing the motor to generate regenerative braking force.

Microcomputer 510 of vehicle control apparatus 500 includes functional units of a target location information recognition unit 511, a vehicle information recognition unit 512, a β angular velocity request value calculation unit 513, a transient area detection unit 514, and a control quantity calculation unit 515, as application programs.

Target location information recognition unit 511 outputs information about a target location ahead of vehicle 100 (in other words, a preview location), specifically, information about a target vehicle speed, which is the target speed of vehicle 100 at a target location, a target curvature at the target location, the time needed for vehicle 100 to reach the target location (in other words, preview location time PT), and the distance to the target location (in other words, preview location distance PD), for example.

The preview location is set to a location ahead of vehicle 100 by a predetermined distance in the direction in which vehicle 100 runs, and the predetermined distance is a constant value or a distance that increases as vehicle speed V increases.

Target location information recognition unit 511 acquires signals from, for example, a global positioning system (GPS) reception unit that measures the latitude and longitude of vehicle 100, a map information database, a radio communication device that performs road-to-vehicle communication and/or vehicle-to-vehicle communication, a camera that acquires information about an image around vehicle 100, and a radar or a Light Detection and Ranging or Laser Imaging Detection and Ranging (LiDAR) that detects objects around vehicle 100. Target location information recognition unit 511 recognizes information about the target location based on the acquired signals.

Vehicle information recognition unit 512 acquires signals from sensors that detect vehicle states, and examples of the sensors include a yaw rate sensor that detects the yaw rate of vehicle 100, a lateral acceleration sensor that detects the lateral acceleration of vehicle 100, a steering angle sensor that detects the steering angle of the front wheels and rear wheels (in other words, the tire angle), a wheel speed sensor that detects the rotation speed of wheels 101 to 104 of vehicle 100.

Based on the outputs of these sensors, vehicle information recognition unit 512 recognizes the yaw rate, the lateral acceleration, the steering angle of the front and rear wheels, and the vehicle speed (in other words, the vehicle body speed), all of which are information about the motion state of vehicle 100, and outputs signals indicating the recognized vehicle information.

β angular velocity request value calculation unit 513, transient area detection unit 514, and control quantity calculation unit 515 are functional units for executing the control of vehicle body sideslip angular velocity Δβ.

In the control of vehicle body sideslip angular velocity Δβ, as will be described in detail below, when running of vehicle 100 transitions from a transient state to a steady state, at least one of the target steering angular velocity and target acceleration/deceleration of vehicle 100 is controlled such that a target vehicle body sideslip angular velocity Δβ_tg exhibits a predetermined temporal rate of change in the transient state.

In other words, in the control of vehicle body sideslip angular velocity Δβ, the steering angular velocity or acceleration/deceleration relating to vehicle body sideslip angular velocity Δβ is planned in advance such that vehicle body sideslip angular velocity Δβ in the future exhibits a predetermined temporal rate of change in a transient state. By changing the steering angle or vehicle speed according to the plan, the temporal rate of change of vehicle body sideslip angular velocity Δβ in a transient state is controlled.

As described above, by controlling the temporal rate of change of vehicle body sideslip angular velocity Δβ in a transient state during vehicle running, vehicle control apparatus 500 prevents change in vehicle behavior, and improves the ground contact feel and the stability of vehicle 100.

The transient state in which the control of vehicle body sideslip angular velocity Δβ is executed is a state in which a vehicle body sideslip angle β changes. Examples of the transient state include a turning transient state in which vehicle 100 runs in a road transitional curve section and a state in which vehicle 100 changes its course for lane change or the like.

In addition, vehicle body sideslip angle β [rad] is the angle formed by the direction in which vehicle 100 runs and the lateral center axis of the vehicle body, and vehicle body sideslip angular velocity Δβ [rad/s] is the time derivative of vehicle body sideslip angle β, that is, the first derivative of vehicle body sideslip angle β.

Furthermore, a vehicle body sideslip angular acceleration ΔΔβ [rad/s²] is the time derivative of vehicle body sideslip angular velocity Δβ, that is, the second derivative of vehicle body sideslip angle β, and corresponds to the temporal rate of change of vehicle body sideslip angular velocity Δβ.

β angular velocity request value calculation unit 513 acquires, from target location information recognition unit 511, the signals of the target vehicle speed, the target curvature at the target location, and the time needed for vehicle 100 to reach the target location (in other words, preview location time PT).

Next, based on the acquired signals about the target location, β angular velocity request value calculation unit 513 calculates target vehicle body sideslip angular velocity Δβ_tg in the future, and outputs a signal indicating target vehicle body sideslip angular velocity Δβ_tg.

Target vehicle body sideslip angular velocity Δβ_tg can be maintained constant until vehicle 100 reaches the target location (in other words, vehicle body sideslip angular acceleration ΔΔβ is zero). Vehicle body sideslip angular velocity Δβ can be maintained constant by maintaining the target steering angular velocity or the target acceleration/deceleration constant.

Instead of maintaining target vehicle body sideslip angular velocity Δβ_tg constant until vehicle 100 reaches the target location, target vehicle body sideslip angular velocity Δβ_tg may be freely set within a range that improves the ground contact feel and the stability of vehicle 100 in a transient state during vehicle running.

Transient area detection unit 514 acquires, from target location information recognition unit 511, the signals of the target vehicle speed, the target curvature at the target location, the time needed for vehicle 100 to reach the target location (in other words, preview location time PT), and the distance to the target location (in other words, preview location distance PD). Transient area detection unit 514 also acquires the signals of the yaw rate, the lateral acceleration, the steering angle of the front and rear wheels, and the vehicle speed from vehicle information recognition unit 512.

Next, based on the acquired signals about the target location and signals about the vehicle information, transient area detection unit 514 determines whether the running state of vehicle 100 is in a transient state in which the control of vehicle body sideslip angular velocity Δβ is executed, and outputs a signal instructing ON or OFF of the control of vehicle body sideslip angular velocity Δβ.

Control quantity calculation unit 515 acquires the signal of target vehicle body sideslip angular velocity Δβ_tg from β angular velocity request value calculation unit 513, and acquires the signal instructing ON or OFF of the control of vehicle body sideslip angular velocity Δβ (in other words, a signal indicating the result of the determination of whether vehicle 100 is in a transient state) from transient area detection unit 514.

In addition, upon acquiring the signal instructing execution of the control of vehicle body sideslip angular velocity Δβ from transient area detection unit 514, control quantity calculation unit 515 outputs signals of the target steering angle and target rotation speed (in other words, the target road wheel speed) based on target vehicle body sideslip angular velocity Δβ_tg to actuator unit 600.

That is, vehicle control apparatus 500 generates a vehicle motion plan for setting vehicle body sideslip angular velocity Δβ to a predetermined temporal rate of change based on information about the path ahead of the vehicle, and controls the steering angle and the vehicle speed based on the generated vehicle motion plan.

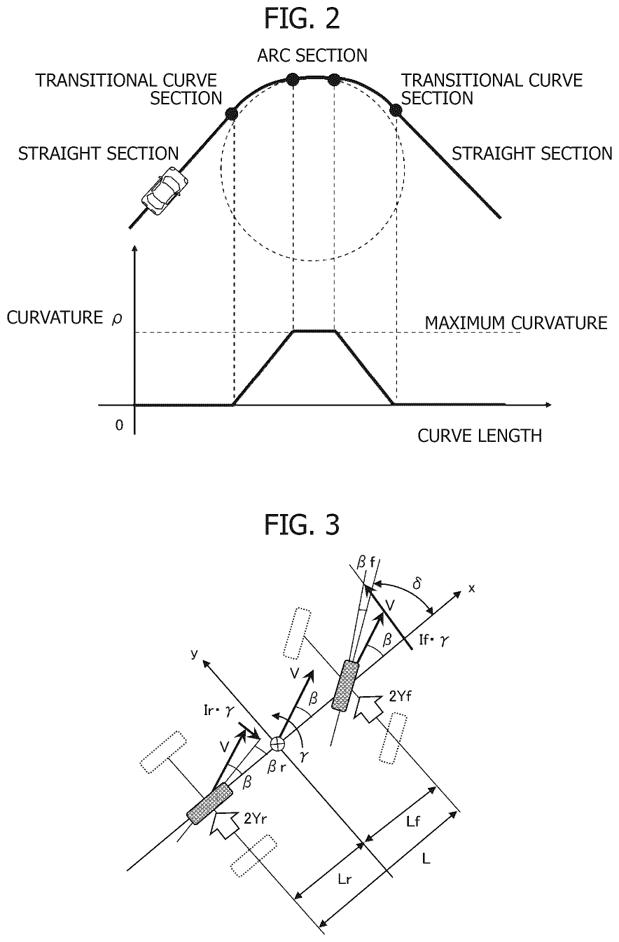

FIG. 2 illustrates a curved path including transitional curve sections, which are transient areas in which the control of vehicle body sideslip angular velocity Δβ is executed.

On the road illustrated in FIG. 2, a transitional curve section (specifically, a clothoid section) is set between an arc section (in other words, a steady turning section) and a straight section.

The arc section is a section in which a curvature p, that is, a turning radius R, is constant, and the individual transitional curve section is a section in which curvature p changes at a constant rate based on the distance (in other words, the curve length).

Thus, when vehicle 100 runs on the road in FIG. 2, vehicle 100 runs in a steady state in the straight sections and the arc section. In the transitional curve sections, vehicle 100 runs in a transient state in which vehicle body sideslip angle β changes.

Vehicle control apparatus 500 executes the control of vehicle body sideslip angular velocity Δβ in a transient state to which vehicle 100 is set when vehicle 100 runs in a transitional curve section, specifically, in a first transitional curve section when running of vehicle 100 transitions from the first transitional curve section to the arc section or in a second transitional curve section when running of vehicle 100 transitions from the second transitional curve section to a straight section.

In a transient state to which vehicle 100 is set when vehicle 100 runs in a transitional curve section, vehicle control apparatus 500 can control at least one of the target steering angular velocity and target acceleration/deceleration of vehicle 100 such that, for example, vehicle body sideslip angular velocity Δβ is maintained constant, in other words, such that target vehicle body sideslip angular acceleration ΔΔβ, which is the time derivative of vehicle body sideslip angular velocity Δβ, is maintained at 0.

To set vehicle body sideslip angular acceleration ΔΔβ to zero, in other words, to maintain vehicle body sideslip angular velocity Δβ at a constant value, in a transitional curve section, vehicle control apparatus 500 sets the target steering angular velocity or the target acceleration/deceleration to a constant value in the transitional curve section.

In a transient state during running of vehicle 100, if vehicle body sideslip angular velocity Δβ greatly changes, the vehicle behavior changes, the ground contact feel and the stability of the vehicle deteriorate, and the sense of security of occupants may deteriorate.

Thus, in the process in which an initial vehicle body sideslip angle β_in (current value) in a first running state in the initial phase of a transient state reaches target vehicle body sideslip angle β_tg (predicted value) in a second running state in which running of vehicle 100 transitions from the transient state to a steady state, vehicle control apparatus 500 previously plans the steering angular velocity and the acceleration/deceleration for the period between the initial phase of the transient state and the steady state such that vehicle body sideslip angle β changes at a constant angular velocity.

That is, based on initial vehicle body sideslip angle β_in and target vehicle body sideslip angle β_tg, vehicle control apparatus 500 calculates target vehicle body sideslip angular velocity Δβ_tg such that vehicle body sideslip angle β changes at a constant angular velocity and vehicle body sideslip angular acceleration ΔΔβ exhibits 0, and sets the target steering angular velocity and target acceleration/deceleration such that vehicle body sideslip angle β changes at target vehicle body sideslip angular velocity Δβ_tg.

In this way, in a transient state during running of vehicle 100, change in vehicle body sideslip angular velocity Δβ is prevented, and the ground contact feel and the stability of the vehicle are improved.

The first running state in the initial phase of a transient state is, for example, when vehicle 100 starts turning. In the case of the road in FIG. 2, the first running state is when vehicle 100 enters a transitional curve section from a straight section and the driver starts increasing the steering angle.

In this case, the second running state in which running of vehicle 100 transitions from a transient state to a steady state is, for example, when vehicle 100 executes steady turning after starting to turn. In the case of the road in FIG. 2, the second running state corresponds to the location of the maximum curvature when vehicle 100 enters the arc section from the transitional curve section.

In addition, the first running state in the initial phase of a transient state is, for example, when vehicle 100 starts increasing or decreasing the steering angle or accelerating/decelerating after ending the steady turning. In the case of the road in FIG. 2, the first running state is when vehicle 100 enters the transitional curve section from the arc section and the driver starts returning the steering angle.

In this case, the second running state in which running of vehicle 100 transitions from a transient state to a steady state is, for example, when vehicle 100 runs straight after ending the turning. In the case of the road in FIG. 2, the second running state is when vehicle 100 enters a straight section from a transitional curve section and vehicle body sideslip angle β returns to 0.

Hereinafter, operating functions of β angular velocity request value calculation unit 513, transient area detection unit 514, and control quantity calculation unit 515 will be described in detail.

Transient area detection unit 514 acquires, from vehicle information recognition unit 512, the information about the motion state of vehicle 100, such as the yaw rate, the lateral acceleration, the steering angle of the front and rear wheels, and the road wheel speed.

Transient area detection unit 514 also acquires, from target location information recognition unit 511, the information about the preview location, such as the target vehicle speed, the target curvature, the time needed for vehicle 100 to reach the preview location, and the distance to the preview location.

Next, based on these various kinds of information acquired, transient area detection unit 514 calculates current vehicle body sideslip angular velocity Δβ, and calculates a target lateral acceleration αy_tg at the preview location.

Here, if current vehicle body sideslip angular velocity Δβ is not 0 and if the difference between target lateral acceleration αy_tg and current lateral acceleration αy_ac is not 0, transient area detection unit 514 determines that vehicle 100 is in a transient state, and outputs a signal instructing execution of the control of vehicle body sideslip angular velocity Δβ to control quantity calculation unit 515.

If it is possible to acquire information about the curvature at the preview location as road shape information or to acquire the information from the lateral slip amount from the target course in the second running state, lateral acceleration αy_tg, a yaw rate γ_tg, and vehicle body sideslip angle β_tg in a state in which there is no centrifugal force on a steady-state turning circle are calculated as expressed by Equations 1.

The information about the curvature at the preview location is information about the maximum curvature in the case of the transitional curve section immediately before the arc section.

$${α}_{y} \_tg = ρ {V}^{2} \\ γ\_tg = \frac{V}{R} \\ β\_tg = \frac{{L}_{r}}{R} \qquad [ Equation 1 ]$$

Thus, by comparing target lateral acceleration αy_tg in the steady state calculated from the curvature at the preview location with current lateral acceleration αy_ac, transient area detection unit 514 can detect a situation in which curvature p will increase and vehicle body sideslip angle β will consequently increase or a situation in which curvature p will decrease and vehicle body sideslip angle β will consequently decrease.

In addition, if current vehicle body sideslip angular velocity Δβ is not 0, transient area detection unit 514 can detect that vehicle 100 is in a transient state, and outputs an instruction for execution of control of vehicle body sideslip angular velocity Δβ so as to manage future change in vehicle body sideslip angle β.

Based on initial vehicle body sideslip angle β_in, target vehicle body sideslip angle β_tg, and predicted time at which vehicle 100 reaches the location corresponding to target vehicle body sideslip angle β_tg, β angular velocity request value calculation unit 513 calculates vehicle body sideslip angular velocity Δβ, which is a constant angular velocity at which vehicle body sideslip angle β changes from initial vehicle body sideslip angle β_in to target vehicle body sideslip angle β_tg, as target vehicle body sideslip angular velocity Δβ_tg. Angular velocity request value calculation unit 513 outputs a signal indicating target vehicle body sideslip angular velocity Δβ_tg to control quantity calculation unit 515.

Maintaining target vehicle body sideslip angular velocity Δβ_tg at a constant value corresponds to maintaining target vehicle body sideslip angular acceleration ΔΔβ_tg at 0.

When transient area detection unit 514 determines that vehicle 100 is in a transient state and outputs a signal instructing execution of the control of vehicle body sideslip angular velocity Δβ, control quantity calculation unit 515 outputs control targets for changing vehicle body sideslip angle β at target vehicle body sideslip angular velocity Δβ_tg to actuator unit 600.

Specifically, control quantity calculation unit 515 calculates a target steering angle in accordance with the target steering angular velocity for changing vehicle body sideslip angle β at target vehicle body sideslip angular velocity Δβ_tg, and a target rotation angular velocity (in other words, target road wheel speed) in accordance with the target acceleration/deceleration for changing vehicle body sideslip angle β at target vehicle body sideslip angular velocity Δβ_tg. Next, control quantity calculation unit 515 outputs a signal indicating the target steering angle and a signal indicating target rotation angular velocity to actuator unit 600. If target vehicle body sideslip angular velocity Δβ_tg is a constant value, the target steering angle and the target acceleration/deceleration are constant values.

Next, the fact that controlling the steering angular velocity and the acceleration/deceleration enables controlling vehicle body sideslip angular velocity Δβ will be described with reference to a two-wheeled model in FIG. 3.

γ denotes the yaw rate, Bf denotes the front wheel sideslip angle, Br denotes the rear wheel sideslip angle, L denotes the wheelbase, Lf denotes the distance from the center of gravity to the front wheel axle, Lr denotes the distance from the center of gravity to the rear wheel axle, m denotes the vehicle weight, Yf denotes the lateral force on the front wheel, and Yr denotes the lateral force on the rear wheel.

A lateral acceleration ay is calculated by Equation 2 based on vehicle body sideslip angular velocity Δβ, yaw rate γ, and vehicle speed V.

$${α}_{y} = ( Δ β + γ ) V \qquad [ Equation 2 ]$$

Front wheel sideslip angle βf and rear wheel sideslip angle βr are calculated in accordance with Equations 3.

$${β}_{f} = β + \frac{{L}_{f}}{V} γ \\ {β}_{r} = β + \frac{{L}_{r}}{V} γ \qquad [ Equation 3 ]$$

Yaw rate γ is expressed by Equation 4 using front wheel sideslip angle βf and rear wheel sideslip angle βr, and vehicle body sideslip angle β is expressed by Equation 5 using front wheel sideslip angle βf and rear wheel sideslip angle βr.

$$γ = \frac{V}{L} ( {β}_{r} - {β}_{f} ) \qquad [ Equation 4 ]$$

$$β = \frac{{L}_{r} {β}_{f} + {L}_{f} {β}_{r}}{L} \qquad [ Equation 5 ]$$

Equations 6 and 7 are obtained by differentiating Equations 4 and 5, respectively.

$$Δ γ = \frac{V}{L} ( Δ {β}_{r} - Δ {β}_{f} ) \qquad [ Equation 6 ]$$

$$Δβ = \frac{{L}_{r} Δ {β}_{f} + {L}_{f} Δ {β}_{r}}{L} \qquad [ Equation 7 ]$$

In addition, from vehicle motion equations, Equations 8 are established. In Equations 8, I_{z} denotes the moment of inertia.

$$2 {Y}_{f} + 2 {Y}_{r} = m V ( Δ β + γ ) = m \cdot {α}_{y} \\ {I}_{z} Δ γ = 2 {L}_{f} {Y}_{f} - 2 {L}_{r} {Y}_{r} \qquad [ Equation 8 ]$$

The motion equations expressing a two-degrees-of-freedom motion with front wheel sideslip angle βf and rear wheel sideslip angle βr are expressed by Equations 9 in which the front wheel steering angle is denoted by δ, the rear wheel steering angle is denoted by δr, and the cornering coefficients of the front and rear wheels are denoted by Cf and Cr.

$$Δ {β}_{f} = - ( \frac{{C}_{f}}{V} + \frac{V}{L} ) {β}_{f} + \frac{V}{L} {β}_{r} + \frac{{C}_{f}}{V} δ \\ {Δβ}_{r} = - ( \frac{{C}_{r}}{V} - \frac{V}{L} ) {β}_{r} - \frac{V}{L} {β}_{f} - \frac{{C}_{r}}{V} {δ}_{r} \qquad [ Equation 9 ]$$

As expressed by Equation 7, vehicle body sideslip angular velocity Δβ changes depending on a front wheel sideslip angular velocity Δβf and a rear wheel sideslip angular velocity Δβr.

In addition, as expressed by Equations 9, front wheel sideslip angular velocity Δβf and rear wheel sideslip angular velocity Δβr change depending on front wheel steering angle δ, rear wheel steering angle δr, and vehicle speed V.

Thus, by controlling front wheel steering angle δ, rear wheel steering angle or, and vehicle speed V, vehicle control apparatus 500 can control vehicle body sideslip angular velocity Δβ in a transient state. In addition, by controlling the target steering angular velocity and the target acceleration/deceleration, vehicle control apparatus 500 can control target vehicle body sideslip angular velocity Δβ_tg, at which vehicle body sideslip angle β changes to target vehicle body sideslip angle β_tg, to a predetermined temporal rate of change.

In addition, by controlling target vehicle body sideslip angular velocity Δβ_tg in a transient state during running of vehicle 100 to a predetermined temporal rate of change, vehicle control apparatus 500 prevents change in vehicle behavior in the transient state, and improves the ground contact feel and the stability of vehicle 100.

Hereinafter, a process in which vehicle control apparatus 500 (specifically, microcomputer 510) controls vehicle body sideslip angular velocity Δβ will be described.

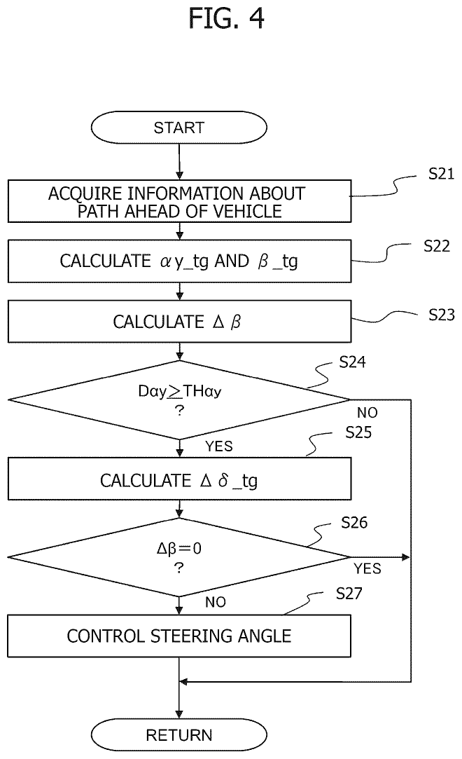

FIG. 4 is a flowchart illustrating a control process in which vehicle control apparatus 500 controls the target steering angular velocity of the front and rear wheels such that target vehicle body sideslip angular velocity Δβ_tg is maintained constant in a transient state.

In step S21, vehicle control apparatus 500 acquires, from information about the path of vehicle 100, information about the target vehicle speed at a preview location, the road curvature at the preview location, the distance to the preview location, and the time needed for vehicle 100 to reach the preview location.

Next, in step S22, vehicle control apparatus 500 calculates lateral acceleration ay at the preview location as target lateral acceleration αy_tg from the target vehicle speed at the preview location of vehicle 100, that is, at the location corresponding to the maximum curvature, the curvature at the preview location, and the time needed for vehicle 100 to reach the preview location.

In addition, in step S22, vehicle control apparatus 500 calculates target vehicle body sideslip angle β_tg, which is vehicle body sideslip angle β at the preview location, based on target lateral acceleration αy_tg and the target vehicle speed.

When vehicle control apparatus 500 can acquire information about the shape of the road ahead of vehicle 100, vehicle control apparatus 500 determines the maximum curvature location of a curve ahead, and calculates target lateral acceleration αy_tg and target vehicle body sideslip angle β_tg from the information about the maximum curvature.

When vehicle 100 runs on an arc section after a transitional curve section, the maximum curvature location is the end point of the transitional curve section, and the maximum curvature is the curvature of the arc section.

In addition, when vehicle 100 is running toward the end of a curve, in other words, when vehicle 100 is running in a transitional curve section immediately before a straight section, vehicle control apparatus 500 sets target vehicle body sideslip angle β_tg and target lateral acceleration αy_tg to 0.

Next, in step S23, vehicle control apparatus 500 calculates current vehicle body sideslip angular velocity Δβ based on a detected value of vehicle speed V and a detected value of lateral acceleration ay (in other words, current lateral acceleration αy_ac).

Next, in step S24, vehicle control apparatus 500 determines, as a first condition for determining that vehicle 100 is in a transient state, whether the absolute value of a difference Day between target lateral acceleration αy_tg and current lateral acceleration αy_ac is equal to or is greater than a predetermined value THαy (THαy>0).

If difference Day is equal to or greater than predetermined value THαy and if a transient state toward the preview location is predicted, vehicle control apparatus 500 proceeds to step S25.

On the other hand, if the first condition for determining that vehicle 100 is in a transient state is not satisfied, and if difference Day is not equal to or greater than predetermined value THαy, vehicle control apparatus 500 ends the present routine, without executing the control of vehicle body sideslip angular velocity Δβ.

In step S25, vehicle control apparatus 500 calculates a target steering angular velocity Δδ_tg for changing vehicle body sideslip angle β at target vehicle body sideslip angular velocity Δβ_tg from current vehicle body sideslip angle β (in other words, initial vehicle body sideslip angle β_in) to target vehicle body sideslip angle β_tg.

When target vehicle body sideslip angular velocity Δβ_tg is maintained constant in a transient state, vehicle control apparatus 500 calculates target steering angular velocity Δδ_tg for constantly changing the current steering angle to the target steering angle corresponding to target vehicle body sideslip angle β_tg.

In other words, by setting target steering angular velocity Δδ_tg to a constant value in a transient state, vehicle control apparatus 500 sets target vehicle body sideslip angular velocity Δβ_tg to a constant value in the transient state.

Next, in step S26, vehicle control apparatus 500 determines, as a second condition for determining that vehicle 100 is in a transient state, whether current vehicle body sideslip angular velocity Δβ is equal to or greater than a predetermined value, for example, whether current vehicle body sideslip angular velocity Δβ is 0.

That is, in step S26, vehicle control apparatus 500 determines whether vehicle body sideslip angle β is changing or is maintained constant.

In this step, if vehicle body sideslip angular velocity Δβ is not 0, that is, if vehicle 100 is running in a transient state in which vehicle body sideslip angle β changes, vehicle control apparatus 500 proceeds to step S27, and executes the control of changing the steering angle based on target steering angular velocity Δδ_tg calculated in step S25.

Specifically, in step S27, vehicle control apparatus 500 determines a steering angular velocity gain based on target steering angular velocity Δδ_tg, and outputs a steering control current based on the steering angular velocity gain to front wheel steering device 601 and rear wheel steering device 602.

In the control of vehicle body sideslip angular velocity Δβ, vehicle control apparatus 500 can control only front wheel steering device 601 between front wheel steering device 601 and rear wheel steering device 602.

As described above, after calculating target steering angular velocity Δδ_tg in step S25, vehicle control apparatus 500 executes the determination about vehicle body sideslip angular velocity Δβ in step S26, in other words, determines whether to start the control of vehicle body sideslip angular velocity Δβ.

In this way, from the time when the first condition about the lateral acceleration is established before the second condition about vehicle body sideslip angular velocity Δβ, the calculation process of target steering angular velocity Δδ_tg is repeated in preparation for the start of the control. As a result, the calculation cycle delay of the control quantities is prevented when the start of the control is determined.

If vehicle body sideslip angular velocity Δβ is 0, that is, if vehicle 100 is running in a steady state, vehicle control apparatus 500 ends the present routine, without executing the control of vehicle body sideslip angular velocity Δβ.

That is, even if there a transient area ahead of vehicle 100, if vehicle 100 is not in the transient area, for example, if vehicle 100 is running in a straight section before a transitional curve section, vehicle control apparatus 500 repeats the calculation process of target steering angular velocity Δδ_tg and waits until vehicle 100 reaches the transient state.

As described above, by executing the process illustrated in the flowchart in FIG. 4, vehicle control apparatus 500 changes the steering angle based on constant target steering angular velocity Δδ_tg in a transient state, for example, during running in a transitional curve section, and prevents change in vehicle body sideslip angular velocity Δβ in the transient state.

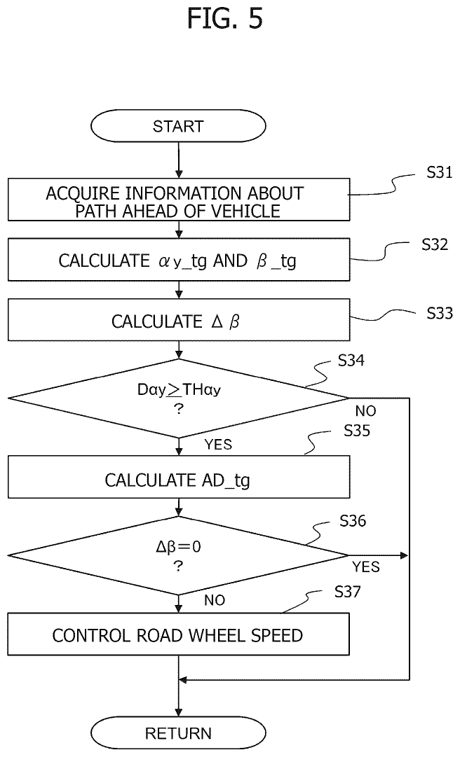

FIG. 5 is a flowchart illustrating a control process in which vehicle control apparatus 500 controls the target acceleration/deceleration of vehicle 100 such that vehicle body sideslip angular velocity Δβ is maintained constant in a transient state.

Because step S31 to step S34 in the flowchart in FIG. 5 are the same as step S21 to step S24 in the flowchart in FIG. 4, detailed description thereof will be omitted.

In step S34, if vehicle control apparatus 500 determines that difference Day is equal to or greater than predetermined value THαy, the process proceeds to step S35.

Next, in step S35, vehicle control apparatus 500 calculates target acceleration/deceleration AD_tg for changing vehicle body sideslip angle β at target vehicle body sideslip angular velocity Δβ_tg from current vehicle body sideslip angle β (in other words, initial vehicle body sideslip angle β_in) to target vehicle body sideslip angle β_tg.

When target vehicle body sideslip angular velocity Δβ_tg is maintained constant in a transient state vehicle, control apparatus 500 calculates target acceleration/deceleration AD_tg for changing the current vehicle speed to the target vehicle speed corresponding to target vehicle body sideslip angle β_tg at a constant acceleration/deceleration.

In other words, by setting target acceleration/deceleration AD_tg in a transient state to a constant value, vehicle control apparatus 500 sets target vehicle body sideslip angular velocity Δβ_tg in the transient state to a constant value.

Next, in step S36, as in step S26, vehicle control apparatus 500 determines whether current vehicle body sideslip angular velocity Δβ is 0.

In step S36, if vehicle control apparatus 500 determines that current vehicle body sideslip angular velocity Δβ is not 0, the process proceeds to step S37.

In step S37, vehicle control apparatus 500 executes the control for changing the vehicle speed based on target acceleration/deceleration AD_tg calculated in step S35.

Specifically, in step S37, vehicle control apparatus 500 determines a rotation speed gain based on target acceleration/deceleration AD_tg.

When vehicle 100 is accelerating, vehicle control apparatus 500 outputs a drive control current based on the rotation speed gain to driving device 603. When vehicle 100 is decelerating, vehicle control apparatus 500 outputs a brake control current based on the rotation speed gain to braking device 604.

As described above, by executing the process illustrated in the flowchart in FIG. 5, in a transient state such as running in a transitional curve section, vehicle control apparatus 500 changes the vehicle speed (road wheel speed) based on constant target acceleration/deceleration AD_tg, and prevents change in vehicle body sideslip angular velocity Δβ in the transient state.

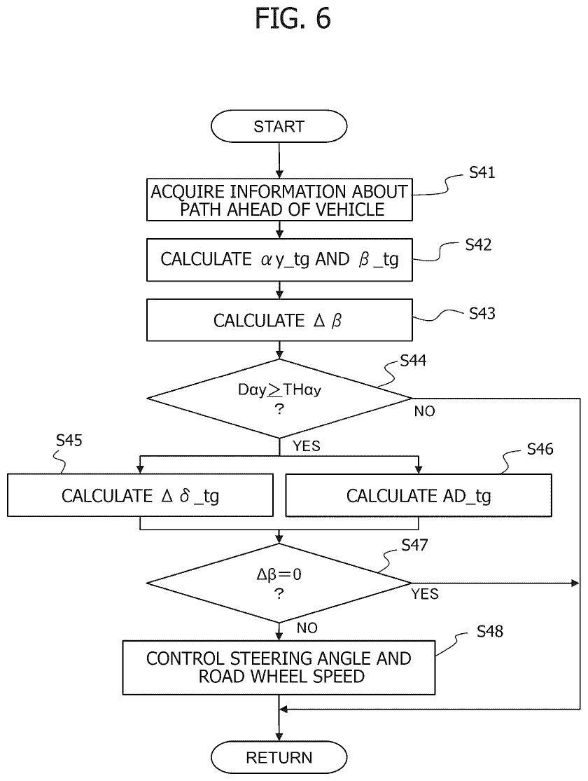

FIG. 6 is a flowchart illustrating a control process in which vehicle control apparatus 500 controls both the target steering angular velocity and the target acceleration/deceleration such that vehicle body sideslip angular velocity Δβ is maintained constant in a transient state.

Because step S41 to step S44 in the flowchart in FIG. 6 are the same as step S21 to step S24 in the flowchart in FIG. 4, detailed description thereof will be omitted.

In step S44, if vehicle control apparatus 500 determines that difference Day is equal to or greater than predetermined value THαy, vehicle control apparatus 500 executes step S45 and step S46 in parallel.

In step S45, as in step S25, vehicle control apparatus 500 calculates target steering angular velocity Δδ_tg. In step S46, as in step S35, vehicle control apparatus 500 calculates target acceleration/deceleration AD_tg.

Next, in step S47, as in step S26, vehicle control apparatus 500 determines whether current vehicle body sideslip angular velocity Δβ is 0.

If vehicle control apparatus 500 determines that current vehicle body sideslip angular velocity Δβ is not 0 in step S47, the process proceeds to step S48.

In step S48, as in step S27, vehicle control apparatus 500 determines a steering angular velocity gain based on target steering angular velocity Δδ_tg, and outputs a steering control current based on the steering angular velocity gain to front wheel steering device 601 and rear wheel steering device 602.

In addition, in step S48, as in step S37, vehicle control apparatus 500 determines a rotation speed gain based on target acceleration/deceleration AD_tg. When vehicle 100 is accelerating, vehicle control apparatus 500 outputs a drive control current based on the rotation speed gain to driving device 603. When vehicle 100 is decelerating, vehicle control apparatus 500 outputs a brake control current based on the rotation speed gain to braking device 604.

As described above, by executing the process illustrated in the flowchart in FIG. 6, in a transient state such as running in a transitional curve section, vehicle control apparatus 500 changes the steering angle based on constant target steering angular velocity Δδ_tg, changes the vehicle speed (road wheel speed) based on constant target acceleration/deceleration AD_tg, and prevents change in vehicle body sideslip angular velocity Δβ in the transient state.

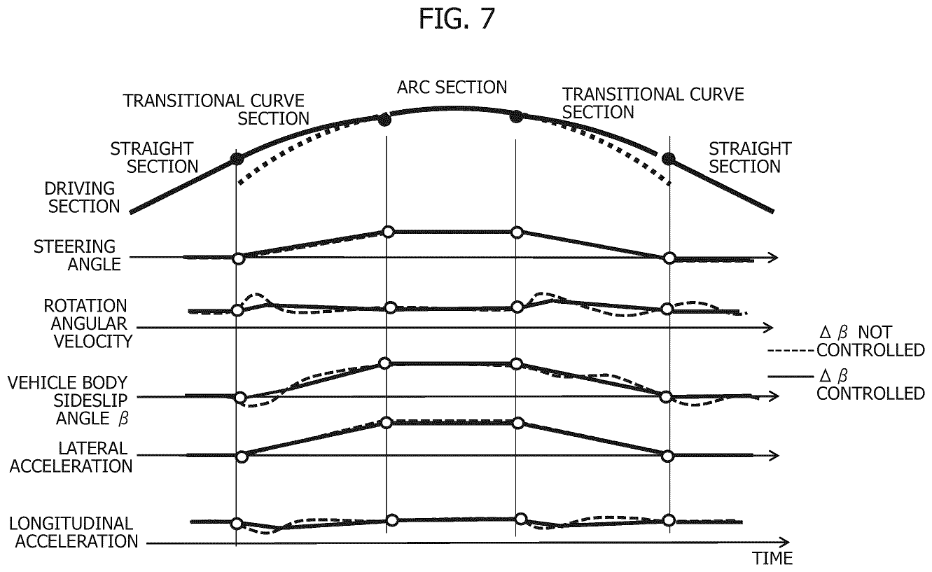

FIG. 7 is a time chart illustrating changes of the front wheel steering angle, the road wheel rotation speed, vehicle body sideslip angle β, the lateral acceleration, and the longitudinal acceleration when vehicle 100 runs on a curved path formed by a straight section, a transitional curve section, an arc section, a transitional curve section, and a straight section in this order.

A solid line in FIG. 7 indicates a state in which vehicle control apparatus 500 executes the control of vehicle body sideslip angular velocity Δβ (specifically, the control in which the target steering angular velocity and the target acceleration/deceleration are maintained constant). A dotted line in FIG. 7 indicates a state in which vehicle control apparatus 500 does not execute the control of vehicle body sideslip angular velocity Δβ.

When the control of vehicle body sideslip angular velocity Δβ is not executed, in a transient state in which vehicle 100 runs in a transitional curve section, vehicle body sideslip angle β unstably changes as the steering angular velocity or acceleration/deceleration changes, and the ground contact feel and the stability of vehicle 100 deteriorate.

In contrast, when the control of vehicle body sideslip angular velocity Δβ is executed, because the target steering angular velocity and the target acceleration/deceleration (in other words, target longitudinal acceleration) are maintained constant in the transient state, vehicle body sideslip angle β changes at constant angular velocity Δβ, and as a result, the ground contact feel and the stability of vehicle 100 in the transient state improve.

Vehicle control apparatus 500 is able to generate a target course for vehicle 100 based on the target location of vehicle 100 such that target vehicle body sideslip angular velocity Δβ_tg exhibits a predetermined temporal rate of change.

That is, vehicle control apparatus 500 is able to generate a target course in view of target steering angular velocity Δδ_tg or target acceleration/deceleration AD_tg such that target vehicle body sideslip angular velocity Δβ_tg exhibits a predetermined temporal rate of change, and is able to control actuator unit 600 such that this target course is traced.

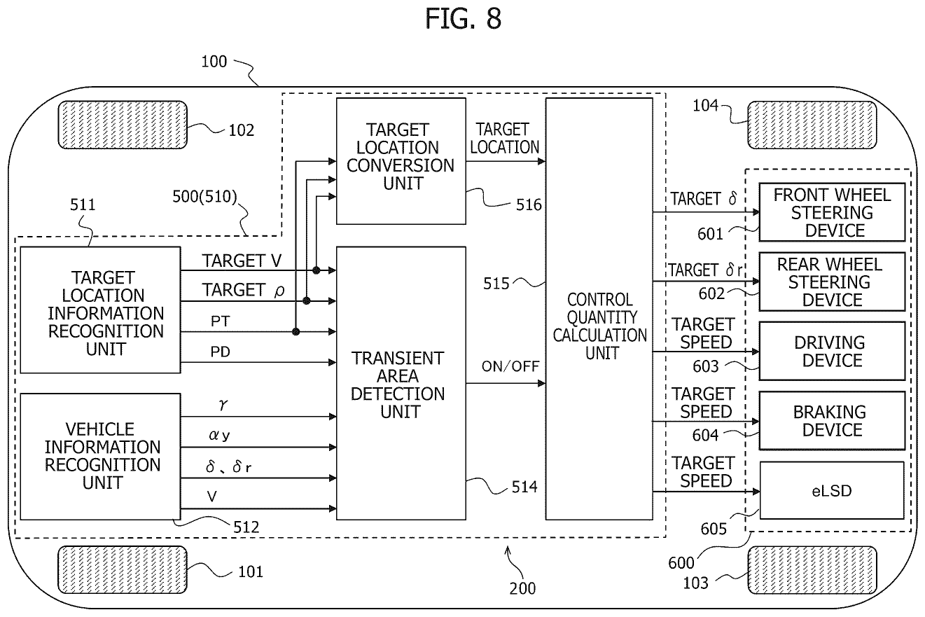

FIG. 8 is a block diagram illustrating vehicle control apparatus 500 that generates a target course as the control of vehicle body sideslip angular velocity Δβ.

Vehicle control apparatus 500 in FIG. 8 includes a target location conversion unit 516, in place of β angular velocity request value calculation unit 513 included in vehicle control apparatus 500 illustrated in FIG. 1.

Target location conversion unit 516 is a functional unit that calculates the target vehicle location in view of vehicle body sideslip angular velocity Δβ_tg.

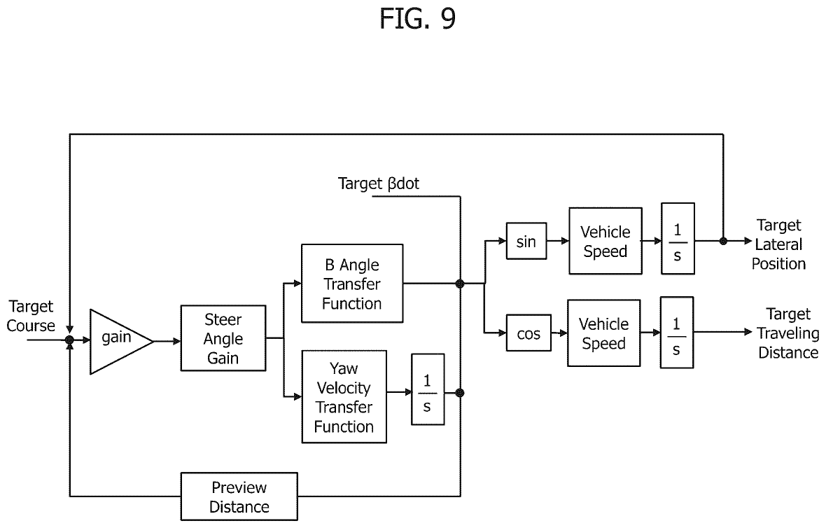

FIG. 9 is a block diagram illustrating detailed signal transmission paths in target location conversion unit 516.

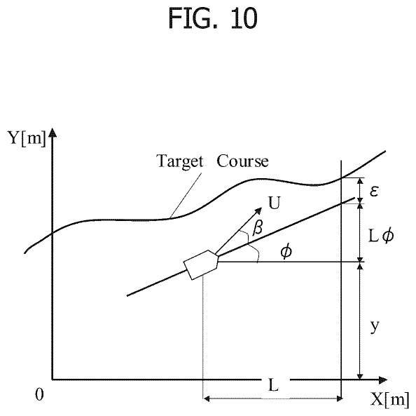

FIG. 10 illustrates a lateral slip amount ε from a target course of vehicle 100 at a preview location in a world coordinate system.

Lateral slip amount ε is calculated in accordance with the following Equation.

$$ε = y + L φ - {y}_{OL}$$

Target location conversion unit 516 converts lateral slip amount ε into steering angle δ, and calculates vehicle body sideslip angle β and yaw rate γ in accordance with Equation 10 and Equation 11.

$$\frac{β ( s )}{δ ( s )} = \frac{{B}_{1} s + {B}_{0}}{{S}_{2} {s}^{2} + {S}_{1} s + {S}_{0}} \qquad [ Equation 10 ]$$

$$\frac{γ ( s )}{δ ( s )} = \frac{{R}_{1} s + {R}_{0}}{{S}_{2} {s}^{2} + {S}_{1} s + {S}_{0}} \qquad [ Equation 11 ]$$

In addition, target location conversion unit 516 calculates a longitudinal vehicle speed and a lateral vehicle speed in accordance with Equation 12 and Equation 13 from vehicle body sideslip angle β and yaw rate γ.

$$\frac{dx}{dt} = V cos ( γ + β ) \qquad [ Equation 12 ]$$

$$\frac{dy}{dt} = V sin ( γ + β ) \qquad [ Equation 13 ]$$

Target location conversion unit 516 calculates a longitudinal vehicle location x and a lateral vehicle location y representing the target vehicle location in accordance with Equation 14 and Equation 15 in view of target vehicle body sideslip angular velocity Δβ_tg, and outputs information about this target vehicle location (specifically, longitudinal vehicle location x and lateral vehicle location y) to control quantity calculation unit 515 as information about the target course.

Control quantity calculation unit 515 controls actuator unit 600 such that vehicle 100 passes through the acquired target vehicle location.

$$x = V \int cos ( γ + Δ β + Δβ\_tg ) dt \qquad [ Equation 14 ]$$

$$y = V \int sin ( γ + Δ β + Δβ\_tg ) dt \qquad [ Equation 15 ]$$

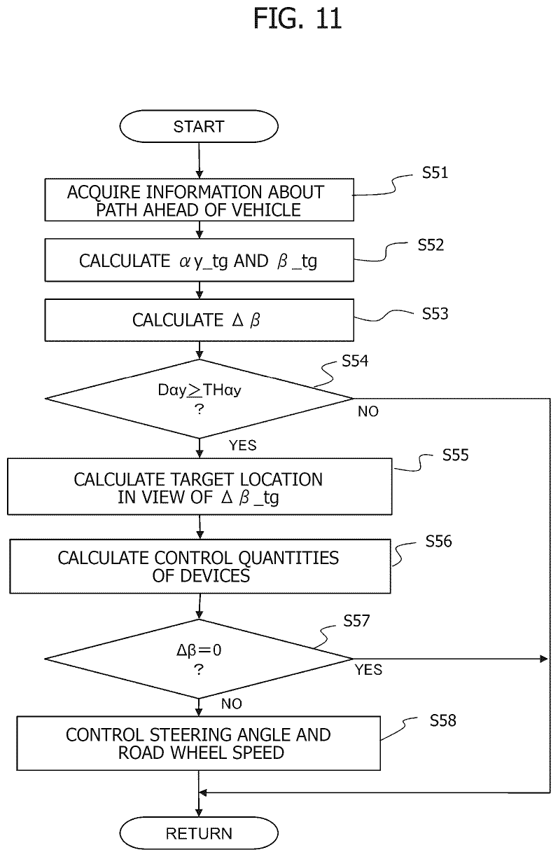

FIG. 11 is a flowchart illustrating a control process executed when a target course is planned in view of target vehicle body sideslip angular velocity Δβ_tg.

Because step S51 to step S54 in the flowchart in FIG. 11 are the same as step S21 to step S24 in the flowchart in FIG. 4, detailed description thereof will be omitted.

In step S54, if vehicle control apparatus 500 determines that difference Day is equal to or greater than predetermined value THαy, the process proceeds to step S55.

In step S55, vehicle control apparatus 500 calculates a target vehicle location in view of target vehicle body sideslip angular velocity Δβ_tg.

This target vehicle location is calculated in accordance with Equation 14 and Equation 15 by target location conversion unit 516 illustrated in FIG. 8, as described above.

Next, in step S56, vehicle control apparatus 500 calculates control quantities, which are the target values of the individual devices for causing vehicle 100 to trace the target vehicle location in view of target vehicle body sideslip angular velocity Δβ_tg.

Next, in step S57, by determining whether current vehicle body sideslip angular velocity Δβ is 0, vehicle control apparatus 500 determines whether vehicle 100 is in a transient state.

If current vehicle body sideslip angular velocity Δβ is not 0, vehicle control apparatus 500 proceeds to step S58. By controlling the driving and braking forces and the steering angle of the front and rear wheels based on the control quantities calculated in step S56, vehicle control apparatus 500 causes vehicle 100 to trace the target vehicle location in view of target vehicle body sideslip angular velocity Δβ_tg.

As described above, by planning a course in view of target vehicle body sideslip angular velocity Δβ_tg, in other words, by modifying the target course such that target vehicle body sideslip angular velocity Δβ_tg is realized, for example, vehicle control apparatus 500 can realize transient running in which target vehicle body sideslip angular velocity Δβ_tg is maintained constant, and can improve the ground contact feel and the stability of vehicle 100 in a transient state during vehicle running.

When target vehicle body sideslip angular velocity Δβ_tg is maintained constant, the target course in view of target vehicle body sideslip angular velocity Δβ_tg is a target course in which the target steering angular velocity and the target acceleration/deceleration are maintained constant in a transient area.

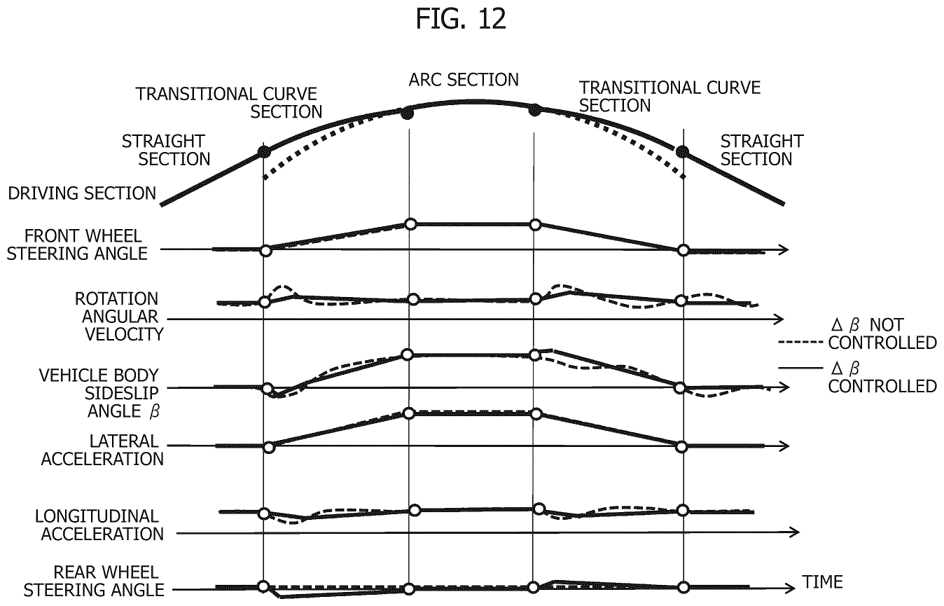

The control of vehicle body sideslip angular velocity Δβ executed by vehicle control apparatus 500 is not limited to the control in which target vehicle body sideslip angular velocity Δβ_tg is maintained constant in a transient state, that is, to the control in which target vehicle body sideslip angular acceleration ΔΔβ_tg is maintained at 0 in a transient state. FIG. 12 is a time chart illustrating an example in which target vehicle body sideslip angular velocity Δβ_tg is not maintained constant in a transient state.

In the example illustrated in FIG. 12, when vehicle 100 begins to enter a transient area, specifically, when vehicle 100 begins to enter a transitional curve section from a straight section or when vehicle 100 begins to enter a transitional curve section from an arc section, target vehicle body sideslip angular velocity Δβ_tg is set such that vehicle body sideslip angle β changes at a constant angular velocity in the turning outward direction of the vehicle body. Thereafter, target vehicle body sideslip angular velocity Δβ_tg is set such that the direction of the change is inverted at some angle, and vehicle body sideslip angle β returns to 0 and changes at a constant angular velocity to the angle corresponding to the maximum curvature in the turning inward direction of the vehicle body.

That is, in the example in FIG. 12, when vehicle 100 begins to enter a transient area, target vehicle body sideslip angular velocity Δβ_tg is set in the direction opposite to the direction of vehicle body sideslip angle β at the preview location. Thereafter, target vehicle body sideslip angular velocity Δβ_tg is inverted to the direction of vehicle body sideslip angle β at the preview location.

The ground contact feel of vehicle 100 can be improved further by first changing vehicle body sideslip angle β in the turning outward direction of the vehicle body and by next changing vehicle body sideslip angle β in the direction of vehicle body sideslip angle β at the preview location, rather than by changing vehicle body sideslip angle β in the direction of vehicle body sideslip angle β at the preview location as soon as vehicle 100 enters the transient area.

When vehicle 100 begins to enter a transitional curve section from a straight section, even when the control of vehicle body sideslip angular velocity Δβ is not executed, vehicle body sideslip angle β temporarily changes in the turning outward direction of the vehicle body, as indicated by a dotted line in FIG. 12.

Target vehicle body sideslip angular velocity Δβ_tg at the time when vehicle 100 begins to enter the transitional curve section from the straight section is set such that the magnitude of vehicle body sideslip angle β in the turning outward direction of the vehicle body does not exceed the magnitude of vehicle body sideslip angle β in the case in which the control of vehicle body sideslip angular velocity Δβ is not executed. In addition, after returning to 0, vehicle body sideslip angle β is set to change at a constant angular velocity to the angle corresponding to the maximum curvature.

By controlling the change of vehicle body sideslip angle β in a transient state at the above-described setting of target vehicle body sideslip angular velocity Δβ_tg, the ground contact feel and the stability of the vehicle can be improved even further.

For example, depending on the rate of change of the curvature, the vehicle speed, etc., vehicle control apparatus 500 can variably set target vehicle body sideslip angular velocity Δβ_tg, the target period, etc., used when changing vehicle body sideslip angle β in the opposite direction in the initial phase of a transitional curve section.

In addition, in the above description, target vehicle body sideslip angular velocity Δβ_tg for changing vehicle body sideslip angle β from zero to vehicle body sideslip angle β at the maximum curvature is maintained constant. However, target vehicle body sideslip angular velocity Δβ_tg may be changed within a predetermined range.

When changing vehicle body sideslip angle β in the turning outward direction of the vehicle body, vehicle control apparatus 500 can control the change of vehicle body sideslip angle β in the turning outward direction of the vehicle body by executing control for lowering the longitudinal acceleration or control for steering rear wheels 103 and 104 to the opposite phase.

In addition, by controlling the difference in driving and braking force between the right and left road wheels, microcomputer 510 can control the yaw moment generated on vehicle 100, and can control change in vehicle body sideslip angle β in the turning outward direction of the vehicle body.

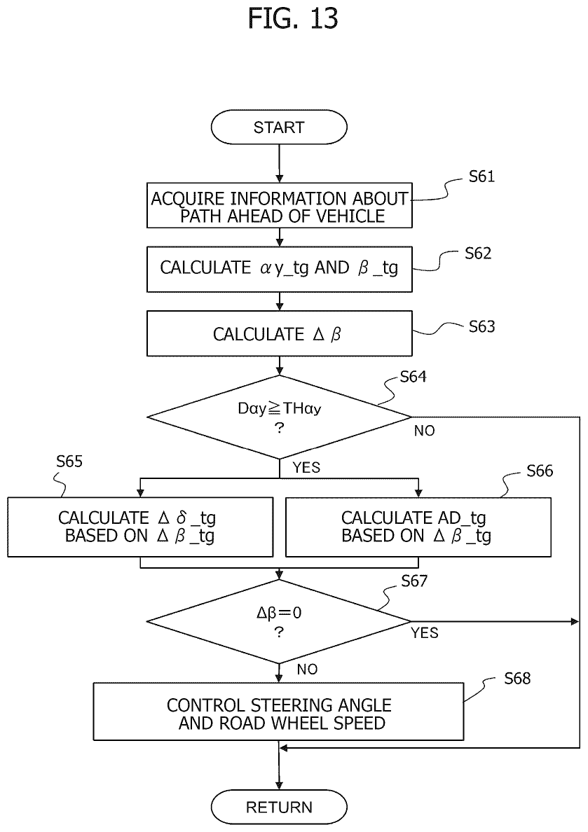

FIG. 13 is a flowchart illustrating a control process in which vehicle control apparatus 500 controls the target steering angular velocity, the target acceleration/deceleration, or the like of the front and rear wheels such that target vehicle body sideslip angular velocity Δβ_tg in a transient state exhibits a predetermined temporal rate of change as illustrated in FIG. 12.

Because step S61 to step S64 in the flowchart in FIG. 13 are the same as step S21 to step S24 in the flowchart in FIG. 4, description thereof will be omitted.

In step S64, if vehicle control apparatus 500 determines that the transient state determination condition is satisfied, that is, that the difference between target lateral acceleration αy_tg and current lateral acceleration αy_ac is equal to or greater than a predetermined value, vehicle control apparatus 500 executes step S65 and step S66 in parallel.

In step S65, vehicle control apparatus 500 calculates target steering angular velocity Δδ_tg in chronological order toward the preview location such that target vehicle body sideslip angular velocity Δβ_tg exhibits a predetermined temporal rate of change as illustrated in FIG. 12, for example.

In the example illustrated in FIG. 12, vehicle control apparatus 500 calculates target steering angular velocity Δδ_tg such that the steering angle of rear wheels 103 and 104 is steered to the opposite phase in the initial phase of the transient state.

In addition, in step S66, vehicle control apparatus 500 calculates target acceleration/deceleration AD_tg in chronological order toward the preview location such that target vehicle body sideslip angular velocity Δβ_tg exhibits a predetermined temporal rate of change as illustrated in FIG. 12, for example.

As described above, to change vehicle body sideslip angle β in the turning outward direction of the vehicle body in the initial phase of a transient state, vehicle control apparatus 500 may control the difference in driving and braking force between the right and left road wheels or may control the electronically controlled LSD. In this way, the yaw moment can be generated.

After calculating target steering angular velocity Δδ_tg and target acceleration/deceleration AD_tg, vehicle control apparatus 500 proceeds to step S67, and determines whether current vehicle body sideslip angular velocity Δβ is 0.

If vehicle body sideslip angular velocity Δβ is not 0 and if vehicle 100 is running in a transient state, vehicle control apparatus 500 proceeds to step S68 and executes the control of vehicle body sideslip angular velocity Δβ.

In step S68, vehicle control apparatus 500 determines rotation speed gains of the road wheels based on target acceleration/deceleration AD_tg at this time, and outputs drive and brake control currents to driving device 603 and braking device 604. In addition, vehicle control apparatus 500 determines steering angular velocity gains based on target steering angular velocity Δδ_tg at this time, and outputs steering control currents to front wheel steering device 601 and rear wheel steering device 602.

On the other hand, if vehicle body sideslip angular velocity Δβ is 0 and vehicle 100 is running in a steady state, that is, if vehicle 100 is running in a steady state before a transient state, vehicle control apparatus 500 ends the present routine, without executing the control of vehicle body sideslip angular velocity Δβ.

As described above, by controlling the target steering angular velocity or the target acceleration/deceleration such that target vehicle body sideslip angular velocity Δβ_tg exhibits predetermined temporal rates of change, not a constant value, vehicle control apparatus 500 can further improve the ground contact feel and the stability of the vehicle body, compared with the case in which target vehicle body sideslip angular velocity Δβ_tg is maintained constant.

The individual technical concepts described in the above-described examples can be appropriately combined and used, as long as there is no conflict.

Although the present invention has thus been described in detail with reference to preferred examples, it will be apparent to those skilled in the art that various kinds of modified modes are possible, based on the basic technical concepts and teachings of the present invention.

For example, vehicle control apparatus 500 may additionally use a condition for executing control of vehicle body sideslip angular velocity Δβ. Whether vehicle speed V exceeds a predetermined speed (for example, the predetermined speed=40 km/h) can be used as the condition.

The above condition on vehicle speed Vis used for executing the control of vehicle body sideslip angular velocity Δβ in an intermediate-to-high vehicle speed range in which the ground contact feel and the stability of the vehicle can be improved. By adding this condition on vehicle speed V, it is possible to prevent ineffective control in a low vehicle speed range from being executed unnecessarily.

If vehicle 100 includes an internal-combustion engine as driving device 603, vehicle control apparatus 500 can control the throttle opening based on the target acceleration/deceleration.

In addition, the control of vehicle body sideslip angular velocity Δβ may be executed either when vehicle 100 enters a transitional curve section from a straight section or when vehicle 100 enters a transitional curve section from an arc section.

### REFERENCE SYMBOL LIST

100 Vehicle
500 Vehicle control apparatus
510 Microcomputer (control unit)
513 β angular velocity request value calculation unit
514 Transient area detection unit
515 Control quantity calculation unit
600 Actuator unit
601 Front wheel steering device
602 Rear wheel steering device
603 Driving device
604 Braking device

1. A vehicle control apparatus, wherein when running of a vehicle transitions from a transient state to a steady state, a control unit included in the vehicle control apparatus controls at least one of a target steering angular velocity and target acceleration/deceleration of the vehicle such that a target vehicle body sideslip angular velocity exhibits a predetermined temporal rate of change in the transient state.

2. The vehicle control apparatus according to claim 1, wherein the predetermined temporal rate of change is 0.

3. The vehicle control apparatus according to claim 2, wherein the control unit maintains the target steering angular velocity or the target acceleration/deceleration constant.

4. The vehicle control apparatus according to claim 3, wherein the control unit
acquires an initial vehicle body sideslip angle, based on a speed of the vehicle and a lateral acceleration of the vehicle in a first running state indicating running of the vehicle in an initial phase of the transient state,
acquires a target vehicle body sideslip angle, based on a target speed of the vehicle and a target lateral acceleration of the vehicle in a second running state in which running of the vehicle transitions from the first running state to the steady state, and
calculates the target vehicle body sideslip angular velocity based on the initial vehicle body sideslip angle and the target vehicle body sideslip angle.

5. The vehicle control apparatus according to claim 4,
wherein the first running state is a state in which the vehicle starts turning, and
wherein the second running state is a state in which the vehicle executes steady turning after the vehicle starts turning.

6. The vehicle control apparatus according to claim 4,
wherein the first running state is a state in which a steering angle of the vehicle is increased or decreased or in which acceleration or deceleration is started after the vehicle ends steady turning, and
wherein the second running state is a state in which the vehicle runs straight after the vehicle ends steady turning.

7. The vehicle control apparatus according to claim 4, wherein when the vehicle body sideslip angular velocity is not 0 and when there is a difference between the target lateral acceleration and the lateral acceleration, the control unit executes the control.

8. The vehicle control apparatus according to claim 1, wherein the control unit controls both the target steering angular velocity and the target acceleration/deceleration.

9. The vehicle control apparatus according to claim 1, wherein the control unit generates a target course of the vehicle based on a target location of the vehicle such that the target vehicle body sideslip angular velocity exhibits a predetermined temporal rate of change.

10. A vehicle control method executed by a control unit provided in a vehicle, wherein the control unit maintains a target steering angular velocity and target acceleration/deceleration of the vehicle constant in a section after the vehicle starts turning until the vehicle executes steady turning.
